(19) United States
(12) Patent Application Publication
(10) Pub. No.: US 2002/0058233 A1
(43) Pub. Date: May 16, 2002

(54) High performance service method

(75) Inventor: Mark P. Meredith, Marietta, GA (US)

Correspondence Address: John R. Pivnichny, Ph.D., IBM Corporation, N50/040-4, 1701 North Street, Endicott, NY, 13760, US

(73) Assignee: International Business Machines Corporation, Armonk, NY (US)

(21) Appl. No.: 10/002,023

(22) Filed: Oct. 18, 2001

Related U.S. Application Data
(63) Continuation-in-part of application No. 09/406,063, filed on Sep. 27, 1999.

(51) Int. Cl. G09B 19/18

(52) U.S. Cl. 434/107

(57) ABSTRACT

A method of increasing the productivity of an organization. Concurrence of a senior leader is obtained. Characteristics representing requirements of the members of the organization for improved productivity are defined in recognizable behavioral terms. Executive norms are created for the leaders and senior leader. Action plans are generated for changing the organization to implement the characteristics not already present and diminish those characteristics that are inconsistent with the required characteristics. Focus groups validate the required characteristics and action plans. Owners for implementing the action plans are assigned and progress in implementing is measured. Progress is optionally celebrated.

This is a continuation-in-part of application Ser. No. 09/406,063, filed Jan. 29, 1999.

### TECHNICAL FIELD

The invention relates generally to methods of improving the productivity of service providing organizations and in particular to improving the productivity of computer information technology service organizations.

### BACKGROUND OF THE INVENTION

Service organizations provide many of the resources needed to operate businesses. For example, an information technology organization may provide services such as workstation selection, procurement, configuration, interconnection, and maintenance. It may also provide software support, help desk operation, user training and many other services associated with information technology used in a business. The service organization may be internal to the business itself, or it may be a completely independent business which provides such services on a contract basis. Providing such services has become a very profitable and competitive area of endeavour. However, in order to remain competitive it is important that the productivity of the service providing organization be increased as much as possible.

One factor which directly affects the productivity of any organization and in particular service providing organizations is the performance technique implemented by the employees and other members of the organization. See S. Robbins in “Organizational Behavior, Prentice Hall, New Jersey, 1998 ISBN 0-13-587459-6. Performance techniques are a set of key characteristics that the organization values. S. Robbins describes on pages 595-596 the following performance technique characteristics as shown in Table 1.

TABLE 1
Characteristics

| | |
|---|---|
| 1. | The level of innovation and risk taking. |
| 2. | The expectation to demonstrate attention to detail. |
| 3. | The focus on results rather than techniques or process |
| | used to achieve these results. |
| 4. | The level of consideration of the effect of results on |
| | the people in the organization. |
| 5. | The level at which work is performed by a team |
| | orientation rather than by individuals working |
| | separately. |
| 6. | The level of aggressive and competitive rather than |
| | easygoing behavior. |
| 7. | The emphasis on activities which maintain stability vs. |
| | growth. |

These characteristics represent a shared understanding of how things are done in an organization and how the members or employees are expected to behave.

A high performance service organization has high productivity, which leads to business success, customer satisfaction and profitability. Some of the characteristics of a high performance service technique include a high degree of customer insight, drive to achieve, team leadership, straight talk, teamwork as a result of business focus, building organizational capability, and coaching.

Many existing organizations have not developed a high performance service technique. Unfortunately it is difficult and time consuming to change an existing performance strategy. In fact, S. Robbins indicates that a crisis may be required to change the performance strategy. He also makes the following suggestions for improving performance strategy: providing positive role models, changing the reward system, transfers, job rotation.

Other authors have proposed processes for improving performance but invariably comment on the great difficulty or impossibility of causing such changes. Connor, D. in Leading at the edge of chaos, John Wiley, 1998, p.88, Deal, T. E. and Kennedy, A. A. In Corporate cultures page 175-176, Schein, E. H. in Organizational culture and leadership pp. 304-305, Kotter, J. P. in “Leading change: Why Transformation Efforts Fail,” of Harvard Business Review, March-April 1995 pp. 59-67, Carr, D. K. in Managing the Change Process pp.144-145 and 147-149, all describe such processes and difficulties and are incorporated herein by reference.

It would therefore constitute a significant advancement in the art of providing services if a method is found for improving productivity of a service providing organization.

### OBJECTS AND SUMMARY OF THE INVENTION

It is therefore, a principal object of the present invention to improve the productivity of a service providing organization.

Another specific object is to bring about this change in an efficient manner in a relatively short period of time.

These and other objects are attained in accordance with one embodiment of the present invention wherein there is provided a method of improving productivity by members of an organization, the method comprising the steps of obtaining concurrence by one or more leaders of the organization to improve the productivity, defining characteristics is recognizable behavioral terms that represent requirements of the members to improve the productivity, identifying which of the required characteristics are not already present in the organization, identifying present characteristics of the organization that are inconsistent with the required characteristics, generating action plans for changing the organization to implement the required characteristics and diminish the inconsistent present characteristics, and measuring progress in implementing the action plans.

In accordance with another embodiment of the present invention there is provided a method of improving productivity by members of an organization having leaders and a senior leader, the method comprising the steps of, obtaining concurrence by the senior leader of the organization to improve the productivity, defining characteristics in recognizable behavioral terms that represent requirements of the members to improve the productivity, creating shared executive norms for the leaders and senior leader in behavioral terms, the norms being compatible with the characteristics, identifying which of the required characteristics are not already present in the organization, identifying present characteristics of the organization that are inconsistent with the required characteristics, generating action plans for changing the organization to implement the required characteristics and the executive norms, and diminish the identified present characteristics, and measuring progress in implementing the action plans.

### BRIEF DESCRIPTION OF THE DRAWINGS

FIG. 1 is a flowchart showing steps of an embodiment of a high performance service method; and

FIG. 2 is a flowchart, showing steps of a method of productivity improvement in accordance with the present invention.

### BEST MODE FOR CARRYING OUT THE INVENTION

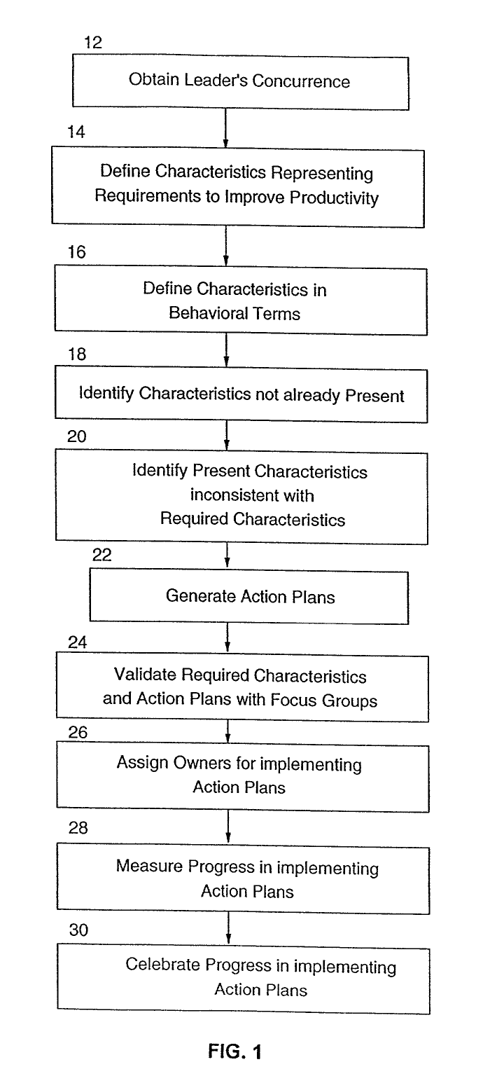

In FIG. 1 there is shown a flowchart of steps of the present invention for improving productivity of members of an organization or an organization itself. The organization may be a service organization which provides information technology services but can also be any type of business organization or any other organization having members who are natural persons. For reasons of clarity of explanation the figure shows a sequence, however, it is not necessary that all steps be done in a particular sequence in order to practice the invention. In step 12 the concurrence of at least one leader of the organization to improve productivity is obtained. The one or more leaders may also be members of the organization although this is not required. Obtaining this concurrence establishes the readiness of the one or more leaders for other changes in the organization which will be made to bring about the desired productivity improvement.

In step 14 characteristics which represent the requirements of the members of the organization for improving productivity are defined. Some examples of such requirements are the production of end products which meet customer needs, the ability to deliver the best choice at the best price or a skilled, experienced support staff.

The requirements are further defined in behavioral terms in step 16 so they can be observed and measured. Some organizational systems and structures that drive behavior are: Communications, Training and Orientation, Leader Modeling Behaviors, Performance/Reward Systems, Policies, Procedures/Plans, Budgets, and Constituency Results. Examples of the resulting observable behaviors are good attitude, responsiveness, flexibility, accessibility, open communication, do what you say, urgency, and sharing resources.

All organizations have present performance characteristics which have built-up over time. In step 18, those required characteristics defined in step 14 which are not already present in the organization are identified. In step 20, any present characteristics which are inconsistent with, conflict with, or are incompatible with the required characteristics of step 14 are identified.

Having made such identifications, action plans are devised in step 22 to promote the development of required characteristics not already present and diminish any present characteristics which are inconsistent with the required characteristic. Action plans may include but are not limited to changing an award system, changing an employee rating program, performing promotion planning, taking an employee morale survey, or acquiring skills through training or education.

In step 24, one or more focus groups are used to validate the required characteristics and action plans. This step may include modifying the action plans by tuning and prioritizing, to close any gaps identified by the focus groups. Focus groups comprise a sample of people in the organization that will implement the action plans. The focus groups operate by choosing a facilitator who solicits input from the groups on the appropriateness of the characteristics and action plans. The facilitator may use a polling mechanism to measure whether the group possesses the tools necessary to carry out the action plans.

In step 26, owners for implementing the action plans are assigned. The owners are preferably members of the organization and more preferably members of the focus groups, but can also be leaders or non-members.

Progress in implementing the action plans is measured in step 28. Some typical measures may be, percent completion, on or behind schedule, over/under budget.

In step 30, which is optional, the members celebrate progress in implementing the action plans. Such celebrations reinforce and recognize progress in bringing about the changes needed to cause a performance improvement. There is no particular number, type, or frequency of celebration required, however a celebration is preferably held frequently enough to help maintain the momentum of the overall performance improvement process.

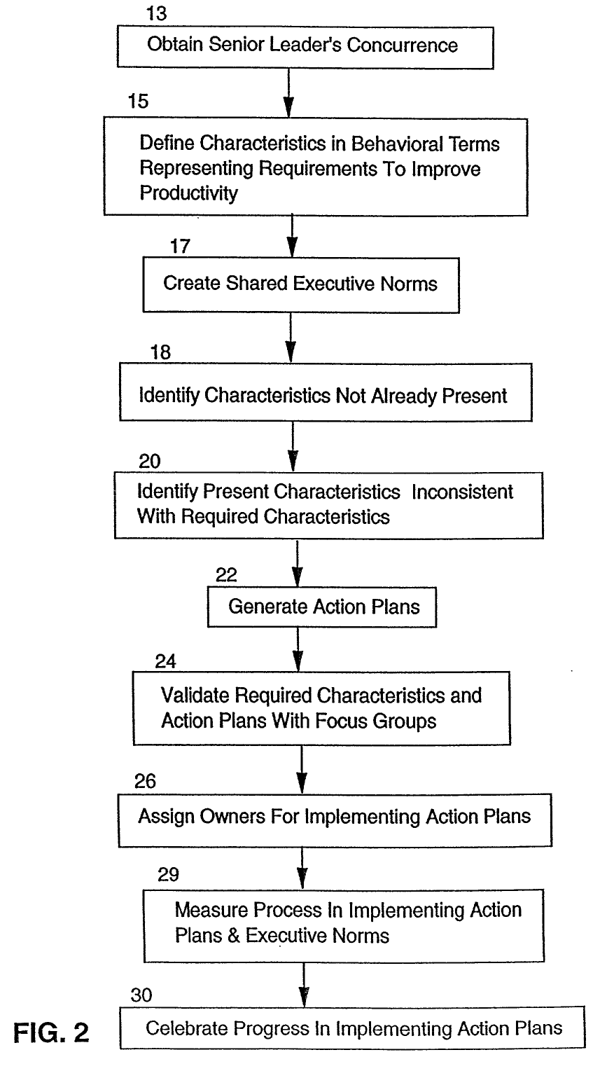

In FIG. 2 there is shown an embodiment of a method of improving productivity by members of an organization having leaders and a senior leader, in accordance with the present invention. As in FIG. 1 the organization may be a service organization which provides information technology services but can also be any type of business organization or any other organization having members who are natural persons. However in FIG. 2 the organization must be large enough to have a plurality of leaders and senior leader who provides direction to the leaders. In step 13 the concurrence of the senior leader to improve the productivity of the members of the organization is obtained. The senior leader may provide this concurrence for any number of reasons including a recognition that the current level of organizational performance will be insufficient in meeting its objectives in the future.

In step 15 characteristics representing requirements of the members to improve productivity are defined in recognizable behavioral terms. In step 17 shared executive norms for leaders and senior leader are created in behavioral terms. The norms have to be compatible with the characteristics of the members as defined in step 15. An executive norm shall be taken herein to mean an agreed upon desired behavior shared by the leaders and senior leader. Executive norms are created in behavioral terms and therefore are readily compared to the characteristics to determine compatibility. However, executive norms apply to the leaders and senior leader whereas characteristics apply to the members. It is not necessary that the executive norms apply to the members or that the characteristics apply to the leaders, although either may be true in a particular organization. It is only necessary that the two be compatible. As used herein compatible shall mean the two are not in conflict or do not result in behaviors which are mutually exclusive or detract from the desired productivity improvement. If the executive norms also apply to the members, then they may be added to the list of characteristics.

Executive norms may be created in a workshop attended by the leaders and senior leader. The workshop may use divergent or convergent brainstorming techniques to assist in creating the executive norms. Other workshop techniques may also be used.

Steps 18-26 are described above.

In step 29 progress in implementing action plans and executive norms is measured. Action plan measurement was previously described in conjunction with step 28 of FIG. 1. Progress in implementing executive norms may be measured by conducting a poll of the leaders. The poll may be taken periodically such as quarterly using computer assisted on-line techniques. The poll may be used to determine how satisfied the leaders are in believing they are behaving according to the created executive norms. Step 30 was described above.

Based on the foregoing, a method of improving the productivity of an organization according to the present invention has been disclosed. However, it will be obvious to those skilled in the art that numerous modifications, changes, and substitutions can be made without deviating from the scope of the present invention. Therefore, the present invention has been disclosed by way of illustration and not limitation and reference should be made to the appended claims to determine the scope of the present invention.

What is claimed:

1. A method of improving productivity by members of an organization having leaders and a senior leader, said method comprising the steps of:
obtaining concurrence by said senior leader of said organization to improve said productivity;
defining characteristics in recognizable behavioral terms that represent requirements of said members to improve said productivity;
creating shared executive norms for said leaders and senior leader in behavioral terms, said norms being compatible with said characteristics;
identifying which of said required characteristics are not already present in said organization;
identifying present characteristics of said organization that are inconsistent with said required characteristics;
generating action plans for changing said organization to implement said required characteristics and said executive norms, and diminish said identified present characteristics; and
measuring progress in implementing said action plans.

2. The method as set forth in claim 1, wherein said shared executive norms are created in a workshop of said leaders and senior leader.

3. The method as set forth in claim 2, wherein said workshop uses divergent or convergent brainstorming techniques.

4. The method as set forth in claim 1, further comprising the step of adding said executive norms to said characteristics for said members.

5. The method as set forth in claim 1, further comprising the step of validating said required characteristics and said action plans with focus groups of said members.

6. The method as set forth in claim 1, further comprising the step of assigning owners for implementing said action plans; and

7. The method as set forth in claim 1, wherein the step of measuring progress includes conducting a poll of said leaders of progress in implementing said executive norms by said leaders and said senior leader.

8. The method as set forth in claim 1, further comprising the step of celebrating said progress in implementing said action plans.
